(19) United States
(12) Patent Application Publication
(10) Pub. No.: US 2024/0318449 A1
(43) Pub. Date: Sep. 26, 2024

(54) Floating Oil Absorption Apparatus and Method

(71) Applicant: Strom W. Smith, Ocean Springs, MS (US)

(72) Inventor: Strom W. Smith, Ocean Springs, MS (US)

(21) Appl. No.: 18/610,664

(22) Filed: Mar. 20, 2024

Related U.S. Application Data
(60) Provisional application No. 63/454,364, filed on Mar. 24, 2023.

(51) Int. Cl. E04H 4/12; C02F 1/40

(52) U.S. Cl. CPC E04H 4/1263; B01J 20/28045; C02F 1/28; C02F 1/40; C02F 1/681; E02B 15/101

(57) ABSTRACT

Embodiments of a floating oil absorption apparatus of the present invention generally include a container having one or more orifices in at least one exterior surface thereof and an oil-absorbent material, wherein the container, with the oil-absorbent material disposed therein, floats in water such that the water can flow into and out of the container, thereby coming into contact with the oil-absorbent material. Methods of using embodiments of the floating oil absorption apparatus are provided.

### CROSS-REFERENCE TO RELATED APPLICATIONS

This application claims the benefit of U.S. Provisional Application No. 63/454,364 filed on Mar. 24, 2023, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

Due to a variety of factors, the water in many water-holding structures, including recreational water basins, becomes contaminated from the introduction of oil-based substances. Examples include swimming pools, wading pools, hot tubs and spas. The oil-based substances may include pump oil, suntan oil/lotion and body oils excreted from people who enter the water. Due to the nonpolar nature of many such oil-based substances and the specific gravity thereof, these impurities are typically immiscible with water and form a thin layer at the surface of the water. These characteristics make it difficult to remove them from the water. Importantly, in addition to being unhygienic and diminishing the appearance of the water, suntan oils, body oils and the like can form a coat of film on a water filtration component and potentially clog and/or reduce the useful lifetime of such filtration means.

Some systems for removing oils from pool water have been reported, including those disclosed in U.S. Pat. No. 7,037,038 to Haski et al., U.S. Pat. No. 6,372,472 to Nehls et al., U.S. Pat. No. 5,980,761 to Boissie et al., U.S. Pat. No. 5,820,758 to Dale et al., U.S. Pat. No. 5,676,839 to Shippert and U.S. Pat. No. 3,868,319 to Black et al., each of which is incorporated by reference herein in its entirety to the extent non inconsistent herewith. While there may be some utility in these systems, they each possess certain drawbacks and/or undesirable features. A need therefore exists for an improved oil removal system for pools and the like.

### BRIEF SUMMARY OF THE INVENTION

Embodiments of a floating absorption apparatus of the present invention generally include a container for an absorbent material, wherein the container is adapted and configured to float in water and comprises one or more orifices that allow the water to enter the container, come into contact with the absorbent material contained therein, and exit the container. In one aspect, the absorbent material may comprise a foam that is formulated to absorb nonpolar substances, such as oils and organic liquids, e.g., solvents.

### BRIEF DESCRIPTION OF THE DRAWINGS

For a more complete understanding of the present invention, reference is now made to the accompanying drawing, in which:

FIG. 1 a depiction of an embodiment of a floating absorption apparatus of the present invention that is floating in water.

### DETAILED DESCRIPTION OF EXEMPLARY EMBODIMENTS OF THE INVENTION

The exemplary embodiments are best understood by referring to the drawings, like numerals being used for like and corresponding parts of the various drawings. In the following description of embodiments, orientation indicators such as “top,” “bottom,” “up,” “down,” “upper,” “lower,” “front,” “back,” etc. are used for illustration purposes only; the invention, however, is not so limited, and other possible orientations are contemplated.

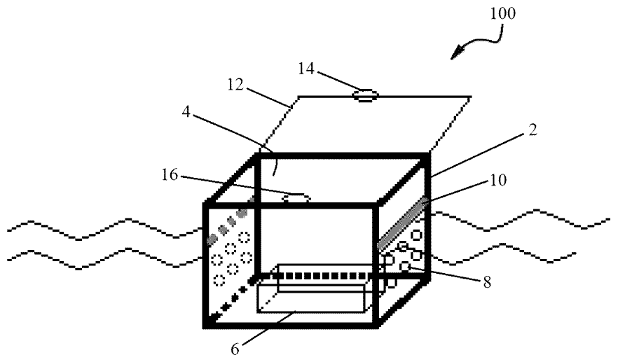

Referring to FIG. 1, therein is depicted an embodiment of a floating absorption apparatus 100 of the present invention floating in water (not separately labeled). Although as previously described the invention is not so limited, for simplicity the apparatus will henceforth be generally referred to as an oil absorption apparatus. In this embodiment, the floating oil absorption apparatus 100 comprises a container 2. In one embodiment, a container 2 comprises any useful size, shape or dimensions. In one embodiment, a container 2 comprises an internal space 4 therein into which an oil-absorbent material 6 can be positioned. In one embodiment, a container 2 comprises one or more orifices 8 in one or more sides/exterior walls (not separately labeled) thereof. In one embodiment, when the floating oil absorption apparatus 100 is floating in water, at least one of the orifices 8 is disposed such that it lies partially below the surface of the water. In one aspect, orifice(s) 8 allow water to flow into the container 2, come into contact with the absorbent material 6, and flow out of the container 2. In one embodiment, a container 2 comprises one or more flotation members 10 that allow for, or assist in, flotation of a container 2 in water, although in other embodiments (not shown) a container 2 may comprise material(s) that permit it to float in water without a need for any flotation members 10. In one embodiment, a flotation member 10 may comprise a low-density material such as, but not limited to, Styrofoam® or the like. In other embodiments (not shown), a flotation member 10 may comprise a fluid-filled reservoir. In one such embodiment, the fluid may comprise air.

In one embodiment, a container 2 comprises a lid 12 that can be opened to allow for insertion of the oil-absorbent material 6 therein and closed to allow for containment of the oil-absorbent material 6 there within. In other embodiments (not shown), a container 2 may comprise other means for insertion into and removal therefrom of the oil-absorbent material 6, as would be understood by one skilled in the art. In one embodiment, a container 2 may comprise a mechanism for securing a lid 12 in a closed position. In the embodiment depicted in FIG. 1, this mechanism comprises a mechanical fastener, such as a latch 14 and a corresponding device, such as a keeper 16 with which latch 14 may be engaged when the lid 12 is closed and with which the latch 14 may be disengaged wo open the closed lid 12. In various embodiments, the mechanism for securing a lid 12 in a closed position may allow for controlled opening of a lid-closed container 2, such as via a locking mechanism or a “child-proof” mechanism, as would be understood by one skilled in the art. In various embodiments (not shown) the container 2 may comprise an overall aesthetically pleasing appearance such that it would be more suitable in a recreational setting.

In one embodiment, an oil-absorbent material 6 may comprise a foam material. In other embodiments, the oil-absorbent material 6 may comprise any suitable material known to absorb oils and/or other substantially nonpolar substances, as would be understood by one skilled in the art. In one embodiment, the foam material 6 may comprise a microcellular, open-cell foam. In one embodiment, the foam material 6 may comprise the E-FoM™ product available from Lone Magnolia Technologies, LLC, D/B/A Lone Magnolia Technology™. In one embodiment, the foam material 6 possesses anti-microbial properties. In one embodiment, the foam material 6 is resistant to fungus, mold and/or mildew growth.

In one aspect, the foam material 6 may be constructed such that after it has adsorbed a quantity of nonpolar substance(s), it may be manipulated (e.g., squeezed, rinsed, etc.) to remove/extract some or substantially all of the nonpolar substance(s), such that the foam material 6 may be reused for absorption purposes. In one embodiment, the foam material 6 may be constructed such that it floats in water. In one embodiment, the foam material 6 may be utilized in the present invention “as is,” while in other embodiments (not shown) the foam material 6 may be disposed within one or more protective casings (e.g., sleeves) that are at least partially water permeable.

### Operation

In operation, an embodiment of a floating oil absorption apparatus 100 of the present invention may be equipped with one or more oil-absorbent materials 6. In one embodiment, once the oil-absorbent material-equipped floating oil absorption apparatus 100 is provided, a lid 12 is closed and secured in a closed orientation utilizing a latch 14 and keeper 16. In one embodiment the closed-lid floating oil absorption apparatus 100 is introduced to a water environment, such as, but not limited to, a swimming pool. Once the user believes that the floating oil absorption apparatus 100 has removed a sufficient amount of nonpolar substance(s) from the water environment, the floating oil absorption apparatus 100 may be removed from the water environment, wherein the lid 12 is opened and one or more of the one or more oil-absorbent materials 6 may be removed from the floating oil absorption apparatus 100. Once the user has removed any of the oil-absorbent materials 6 from the floating oil absorption apparatus 100, such oil-absorbent material(s) 6 may be manipulated to remove some or substantially all of the absorbed nonpolar substance(s) therefrom, as described herein and as would be understood by one skilled in the art. The removed oil-absorbent material(s) 6 may be reintroduced into the floating oil absorption apparatus 100 for further use or discarded, as appropriate. In one aspect, the floating oil absorption apparatus 100 may be removed from the water environment to remove one or more of the oil-absorbent material(s) 6 therefrom, or the oil-absorbent material(s) 6 may be removed therefrom while the floating oil absorption apparatus 100 remains in the water environment.

### Method

An exemplary method utilizing an embodiment of a floating oil absorption apparatus of the present invention comprises:

A Floating Oil Absorption Apparatus Provision Step, comprising providing a floating oil absorption apparatus, such as floating oil absorption apparatus 100;

An Oil-Absorbent Material Provision Step, comprising providing at least one oil-absorbent material, such as oil-absorbent material 6, at least partially within the floating oil absorption apparatus;

Floating Oil Absorption Apparatus Water Introduction Step, comprising providing the floating oil absorption apparatus equipped with the oil-absorbent material(s) to a water environment; and

A Floating Oil Absorption Apparatus Operation Step, comprising operating the oil-absorbent material(s)-equipped floating oil absorption apparatus by allowing it to float in the water environment.

Optionally, one or both of the following steps may be performed:

A Floating Oil Absorption Apparatus Restoration Step; comprising removing at least one oil-absorbent material from the floating oil absorption apparatus, removing at least some of the absorbed nonpolar material therefrom, and reintroducing the oil-absorbent material back into the floating oil absorption apparatus; and/or

A Floating Oil Absorption Apparatus Replacement Step, comprising removing at least one oil-absorbent material from the floating oil absorption apparatus, and introducing a different oil-absorbent material into the floating oil absorption apparatus to replace the removed oil-absorbent material(s)

The foregoing methods are merely exemplary, and additional embodiments of utilizing a floating oil absorption apparatus of the present invention consistent with the teachings herein may be employed. In addition, in other embodiments, one or more of these steps may be performed concurrently, combined, repeated, re-ordered, or deleted, and/or additional steps may be added.

The foregoing description of the invention illustrates exemplary embodiments thereof. Various changes may be made in the details of the illustrated construction and process within the scope of the appended claims by one skilled in the art without departing from the teachings of the invention. The present invention should only be limited by the claims and their equivalents.

1. A floating absorption apparatus, comprising:
a container; and
one or more absorbent materials;
wherein:
said absorbent materials are removably positionable at least partially within said container;
said container comprises one or more orifices in at least one exterior wall thereof; and
said container is adapted and configured to float in water.

2. The floating absorption apparatus of claim 1, wherein said absorbent material comprises a material formulated to absorb substantially non-polar substances.

3. The floating absorption apparatus of claim 1, wherein said absorbent material comprises a material formulated to absorb oils.

4. The floating absorption apparatus of claim 1, wherein said absorbent material comprises a material formulated to absorb organic liquids.

5. The floating absorption apparatus of claim 1, wherein said absorbent material comprises foam.

6. The floating absorption apparatus of claim 5, wherein said foam comprises a microcellular, open-cell foam.

7. The floating absorption apparatus of claim 1, wherein said absorbent material possesses anti-microbial properties.

8. The floating absorption apparatus of claim 1, wherein said absorbent material possesses one or more properties selected from the group consisting of:
resistance to fungal growth;
resistance to mold growth; and
resistance to mildew growth.

9. The floating absorption apparatus of claim 1, wherein said absorbent material, after it has been utilized to absorb a quantity of one or more substantially non-polar substances, can be manipulated to remove and/or extract at least a portion of said non-polar substance(s) therefrom such that the absorbent material can be reused for absorption of non-polar substance(s).

10. The floating absorption apparatus of claim 9, wherein said manipulation comprises a process selected from the group consisting of:
squeezing;
rinsing; and
both squeezing and rinsing.

11. A method of operating the floating absorption apparatus of claim 1, comprising:
providing said container;
positioning at least one absorbent material at least partially into said container; and
introducing said absorbent material-equipped floating absorption apparatus into a water environment.

12. The method of operating the floating absorption apparatus of claim 11, wherein said absorbent material absorbs substantially non-polar substances floating within said water environment.

13. The method of operating the floating absorption apparatus of claim 11, wherein said absorbent material absorbs oils floating within said water environment.

14. The method of operating the floating absorption apparatus of claim 11, wherein said absorbent material absorbs organic liquids floating within said water environment.

15. The method of operating the floating absorption apparatus of claim 11, wherein said absorbent material comprises a microcellular, open-cell foam.

16. The method of operating the floating absorption apparatus of claim 11, wherein said absorbent material possesses anti-microbial properties.

17. The method of operating the floating absorption apparatus of claim 11, wherein said absorbent material possesses one or more properties selected from the group consisting of:
resistance to fungal growth;
resistance to mold growth; and
resistance to mildew growth.

18. The method of operating the floating absorption apparatus of claim 11, wherein said absorbent material, after it has been utilized to absorb a quantity of one or more substantially non-polar substances, is then manipulated to remove and/or extract at least a portion of said non-polar substance(s) therefrom such that the absorbent material can be reused for absorption of non-polar substance(s).

19. The method of operating the floating absorption apparatus of claim 18, wherein said manipulation comprises a process selected from the group consisting of:
squeezing;
rinsing; and
both squeezing and rinsing.
